(19) United States
(12) Patent Application Publication
(10) Pub. No.: US 2014/0156889 A1
(43) Pub. Date: Jun. 5, 2014

(54) APPARATUS AND METHOD FOR MONITORING SIGNALS TRANSMITTED IN BUS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: KANG-BIN WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/945,103

(22) Filed: Jul. 18, 2013

(30) Foreign Application Priority Data
Dec. 4, 2012 (CN) 2012105112625

(51) Int. Cl. G06F 13/42

(52) U.S. Cl. CPC G06F 13/42
USPC 710/106

(57) ABSTRACT

A signal monitor includes a signal collecting unit, two registers, a processing unit, and a Universal Asynchronous Receiver/Transmitter (UART). The signal collecting unit collects real-time signals from a bus, converts the real-time signals into accessible data, and stores the accessible data in the two registers. The processing unit reads the accessible data from the two registers and determines status of the real-time signals by examining the accessible data in the reading. The UART asynchronously transmits the status of the real-time signals to a control terminal. A method for monitoring signals transmitted in a bus is also provided.

### REFERENCE TO RELATED APPLICATIONS

This application claims all benefits accruing under 35 U.S.C. §119 from China Patent Application No. 201210511262.5, filed on Dec. 4, 2012 in the State Intellectual Property Office of China. The contents of the China Application are hereby incorporated by reference. In addition, subject matter relevant to this application is disclosed in: co-pending U.S. patent application entitled “APPARATUS AND METHOD FOR MONITORING SIGNALS TRANSMITTED IN BUS,” Attorney Docket Number US48035, application Ser. No. [to be advised], filed on the same day as the present application. This application and the co-pending U.S. patent applications are commonly owned, and the contents of the co-pending U.S. patent applications are hereby incorporated by reference.

### BACKGROUND

1. Technical Field

The disclosure generally relates to data communication, and particularly relates to apparatuses and methods for monitoring real-time signals transmitted in a bus.

2. Description of Related Art

For serial data communication between multiple devices, the Inter-Integrated Circuit (I2C) bus and the Serial Peripheral Interface (SPI) bus have been developed and widely accepted in the consumer electronics, telecommunications and industrial electronics fields. However, it is difficult to acquire the status of real-time signals transmitted in the I2C bus or the SPI bus.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a data communication system equipped with a signal monitor.

FIG. 2 is a block diagram of one embodiment of a signal monitor.

FIG. 3 is a block diagram of one embodiment of a control terminal.

FIGS. 4 and 5 show a flowchart of one embodiment of a method for monitoring real-time signals transmitted in a bus.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

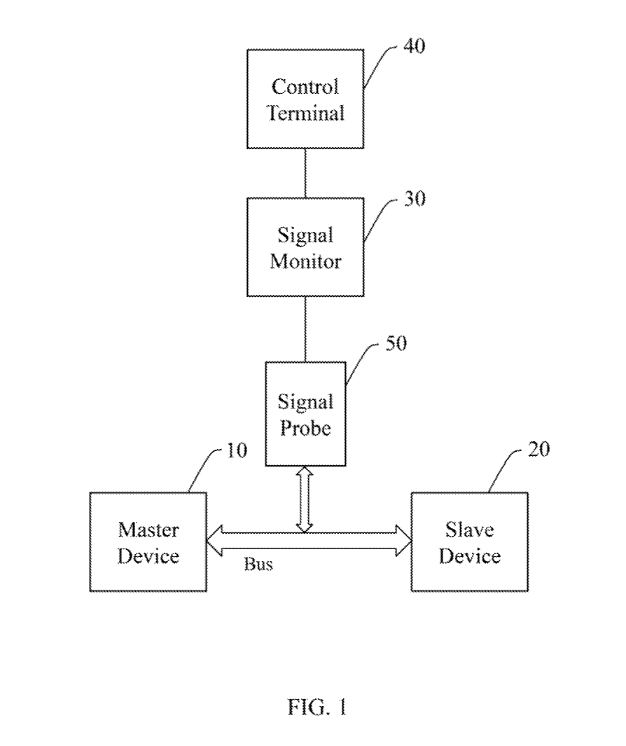

FIG. 1 shows one embodiment of a data communication system. The data communication system includes a master device 10, a slave device 20, a signal monitor 30, a control terminal 40, and a signal probe 50.

The master device 10 is connected to the slave device 20 via a bus, for example, an I2C bus or a SPI bus. An I2C bus includes a Serial Data (SDA) line and a Serial Clock (SCL) line. An SPI bus includes a Master-Out-Slave-In (MOSI) line, a Master-In-Slave-Out (MISO) line, a Serial Clock (SCL) line, and a Slave Select (SS) line. The master device 10 and the slave device 20 can exchange data via the bus.

The signal probe 50 is electrically connected to the bus that interconnects the master device 10 the slave device 20. The signal monitor 30 is connected to the bus through the signal probe 50. The signal monitor 30 collects real-time signals transmitted in the bus, through the signal probe 50. In some embodiments, the signal probe 50 includes a unidirectional transmission module (not shown) which prevents any signal from being transmitted or fed back from the signal monitor 30 to the bus. Thus, the signal monitor 50 is prevented from damaging signals transmitted in the bus.

When the signal monitor 30 collects real-time signals transmitted in the bus, the signal monitor 30 can examine the real-time signals and report the status of the real-time signals to the control terminal 40.

The control terminal 10 provides a user interface for displaying the status of the real-time signals transmitted in the bus. The control terminal 10 may be a personal computer, a server computer, a tablet computer, or the like.

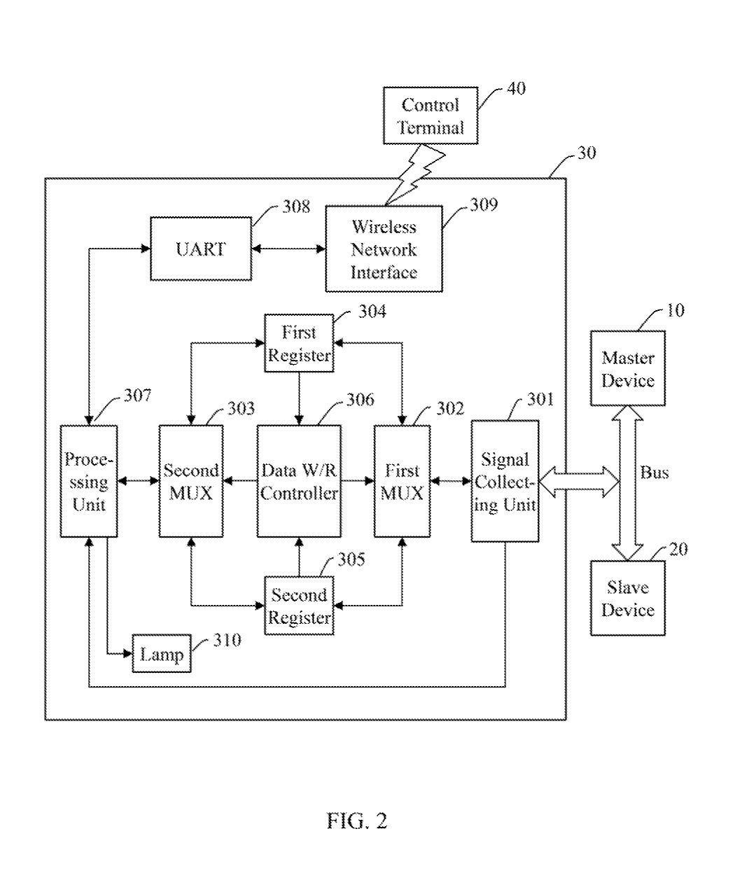

FIG. 2 shows one embodiment of the signal monitor 30. The signal monitor 30 includes a signal collection unit 301, a first multiplexer 302, a second multiplexer 303, a first register 304, a second register 305, a data write/read (W/R) controller 306, a processing unit 307, a Universal Asynchronous Receiver/Transmitter (UART) 308, a wireless network interface 309, and an indicating lamp 310.

The signal collecting unit 301 collects the real-time signals transmitted in the bus through the signal probe 50 and converts the collected real-time signals into accessible data according the protocol of the bus, for example, the I2C bus protocol or the SPI bus protocol. The signal connecting unit 301 transmits the accessible data to the first multiplexer 302.

The first multiplexer 302 selectively stores the accessible data in the first register 304 and the second register 305. In some embodiments, each of the first register 304 and the second register 305 is a First Input First Output (FIFO) register. Thus, the accessible data which is firstly stored in the first register 304 or the second register 305 can be read firstly from the first register 304 or the second register 305.

The processing unit 307 transmits a read command to the second multiplexer 303. In response to the read command, the second multiplexer 303 selectively reads the accessible data in the first register 304 and the second register 305. The second multiplexer 303 transmits the accessible data to the processing unit 307.

When the first register 304 is full, the first register 304 sends an out-of-space signal to the data W/R controller 306. In response to the out-of-space signal from the first register 304, the data W/R controller 306 sets the first register 304 to a write-protected state and informs the first multiplexer 302 and the second multiplexer 303 that the first register 304 is full. The first multiplexer 302 then selects for storage purposes the second register 305 and stores the accessible data in the second register 305. The second multiplexer 303 selects the first register 304 and reads accessible data from the first register 304. When the second multiplexer 303 has finished reading the accessible data from the first register 304, the data W/R controller 306 sets the first register 304 to a write-permitted state. Then the first multiplexer 302 then can again select the first register 304 for storage of subsequent accessible data.

Similarly, when the second register 305 is full, the second register 305 sends an out-of-space signal to the data W/R controller 306. In response to the out-of-space signal from the second register 305, the data W/R controller 306 sets the second register 305 to a write-protected state and informs the first multiplexer 302 and the second multiplexer 303 that the second register 305 is full. The first multiplexer 302 selects the first register 304 for storage of accessible data. The second multiplexer 303 selects the second register 305 and reads accessible data from the second register 305. When the second multiplexer 303 has finished reading the accessible data from the second register 305, the data W/R controller 306 sets the second register 305 to a write-permitted state. Then the first multiplexer 302 then can again select the second register 305 for storage of subsequent accessible data.

When both of the first register 304 and the second register 305 are full, the first multiplexer 302 suspends the accessible data transmitted from the signal collecting unit 301 and the signal collecting unit 301 suspends collecting real-time signals from the bus, until either of the first register 304 and the second register 305 is again set to the write-permitted state.

When both of the first register 304 and the second register 305 are full, the second multiplexer 303 may select any of the first register 304 and the second register 305 and read the accessible data from either of the first register 304 and the second register 305.

When both of the first register 304 and the second register 305 are in the write-permitted state, the second multiplexer 303 enters a standby state and suspends reading data from any of the first register 304 and the second register 305, until either of the first register 304 and the second register 305 is full.

When the processing unit 307 receives the accessible data from the second multiplexer 303, the processing unit 307 determines status of the real-time signals transmitted in the bus by examining the accessible data. The processing unit 307 then transmits the status of the real-time signals to the UART 308.

The UART 308 asynchronously transmits the status of the real-time signals to the wireless network interface 309.

The wireless network interface 309 establishes a wireless connection with the control terminal 40 and transmits the status of the real-time signals to the control terminal 40 via the wireless connection.

The indicating lamp 310 indicates the working status of the signal monitor 30. While the processing unit 307 is examining the accessible data, the processing unit 307 controls the indicating lamp 310 to flicker.

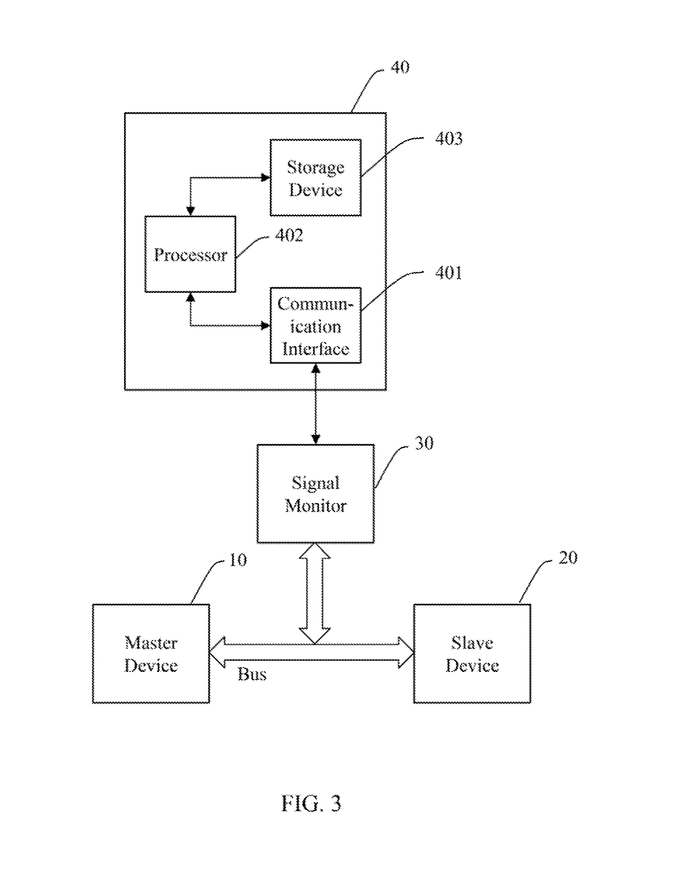

FIG. 3 shows one embodiment of the control terminal 40. The control terminal 40 includes a communication interface 401, a processor 402 and a storage device 403.

The communication interface 401 establishes a wireless connection with the wireless network interface 309 of the signal monitor 30 and receives the status of the real-time signals from the signal monitor 30 via the wireless connection. The communication interface 401 transmits the status of the real-time signals to the processor 402. The processor 402 stores the status of the real-time signals in the storage device 403.

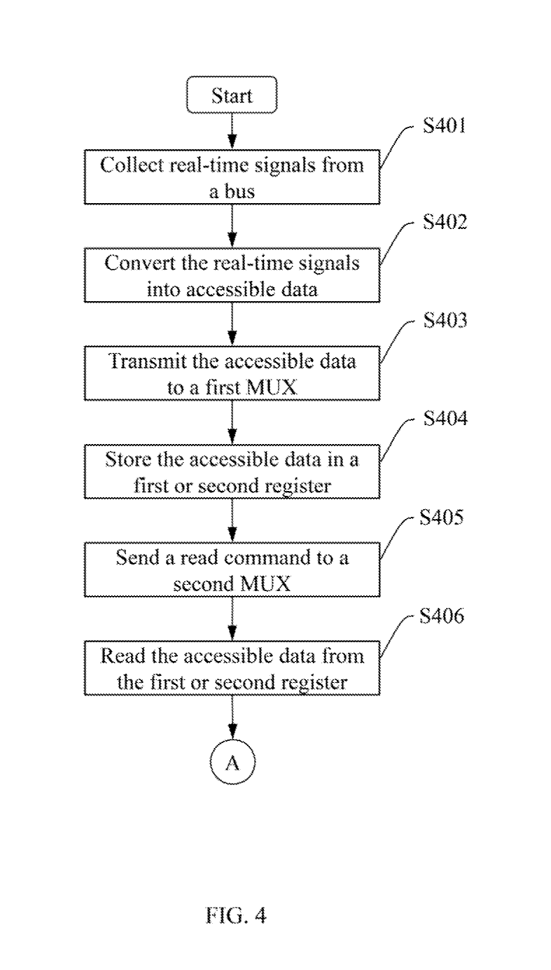

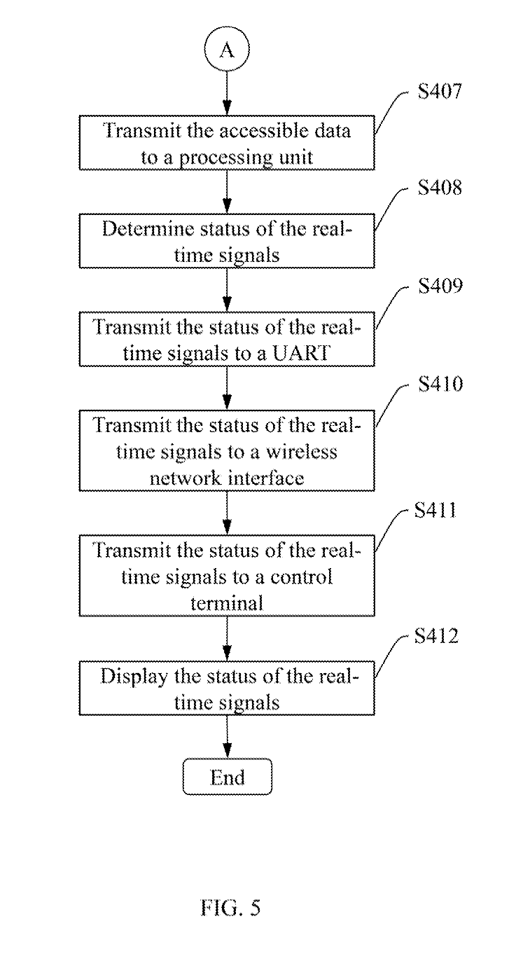

FIGS. 4 and 5 show a flowchart of one embodiment of a method for monitoring real-time signals transmitted in a bus. The method includes the following steps.

In step S401, the signal collecting unit 301 collects real-time signals from a bus through the signal probe 50.

In step S402, the signal collecting unit 301 converts the real-time signals into accessible data according to the protocol of the bus.

In step S403, the signal collecting unit 301 transmits the accessible data to the first multiplexer 302.

In step S404, the first multiplexer 302 selectively stores the accessible data in the first register 304 and the second register 305.

In step S405, the processing unit 307 transmits a read command to the second multiplexer 303.

In step S406, in response to the read command, the second multiplexer 303 selectively reads the accessible data from the first register 304 and the second register 305.

In step S407, the second multiplexer 303 transmits the accessible data to the processing unit 307.

In step S408, the processing unit 307 determines status of the real-time signals transmitted in the bus by examining the accessible data.

In step S409, the processing unit 307 transmits the status of the real-time signals to the UART 308.

In step S410, the UART 308 asynchronously transmits the status of the real-time signals to the wireless network interface 309.

In step S411, the wireless network interface 309 establishes a wireless connection with the control terminal 40 and transmits the status of the real-time signals to the control terminal 40 via the wireless connection.

In step S412, the control terminal 10 provides a user interface for displaying the status of the real-time signals.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A signal monitor, comprising:
a signal collecting unit adapted to collect real-time signals from a bus, to convert the real-time signals into accessible data;
a first register and a second register adapted to store the accessible data;
a processing unit adapted to retrieve the accessible data from the first register and the second register, to determine status of the real-time signals by examining the accessible data; and
a Universal Asynchronous Receiver/Transmitter (UART) adapted to asynchronously transmit the status of the real-time signals to a control terminal.

2. The signal monitor of claim 1, further comprising a first multiplexer, wherein the signal collecting unit is further adapted to transmit the accessible data to the first multiplexer, the first multiplexer is adapted to selectively store the accessible data in the first register and the second register.

3. The signal monitor of claim 2, further comprising a second multiplexer, wherein the processing unit is further adapted to send a read command to the second multiplexer, the second multiplexer is adapted to selectively read the accessible data from the first register and the second register and to transmit the accessible data to the processing unit in response to the read command.

4. The signal monitor of claim 3, further comprising a data Write/Read (W/R) controller, wherein when the first register is full, the data W/R controller is adapted to set the first register to a write-protected state, when the second register is full, the data W/R controller is adapted to set the second register to a write-protected state.

5. The signal monitor of claim 4, wherein when the first register is in the write-protected state, the first multiplexer is adapted to store the accessible data in the second register, when the second register is in the write-protected state, the first multiplexer is adapted to store the accessible data in the first register, when both of the first and second registers are in the write-protected state, the first multiplexer is adapted to suspend the accessible data transmitted from the signal collecting unit.

6. The signal monitor of claim 5, wherein when both of the first and second registers are in the write-protected state, the signal collecting unit is adapted to suspend collecting the real-time signals from the bus.

7. The signal monitor of claim 6, wherein when the second multiplexer has finished reading the accessible data from the first register, the data W/R controller is adapted to set the first register to a write-permitted state, when the second multiplexer has finished reading the accessible data from the second register, the data W/R controller is adapted to set the second register to a write-permitted state.

8. The signal monitor of claim 1, wherein each of the first and second registers is a First Input First Output (FIFO) register.

9. The signal monitor of claim 1, further comprising an indicating lamp adapted to flicker while the processing unit is examining the accessible data.

10. The signal monitor of claim 1, further comprising a wireless network interface adapted to establish a wireless connection with the control terminal and to transmit the status of the real-time signals to the control terminal via the wireless connection.

11. A method for monitoring signals transmitted in a bus, the method comprising:
collecting real-time signals from a bus and converting the real-time signals into accessible data by a signal collecting unit;
storing the accessible data in a first register and a second register by a first multiplexer;
retrieving the accessible data from the first register and the second register and determining status of the real-time signals by examining the accessible data by a processing unit; and
asynchronously transmitting the status of the real-time signals to a control terminal by a UART.

12. The method of claim 11, further comprising transmitting the accessible data to a first multiplexer by the signal collecting unit, wherein the first multiplexer selectively stores the accessible data in the first register and the second register.

13. The method of claim 12, further comprising sending a read command to the second multiplexer by the processing unit, wherein the second multiplexer selectively reads the accessible data from the first register and the second register and transmits the accessible data to the processing unit in response to the read command.

14. The method of claim 13, further comprising:
when the first register is full, setting the first register to a write-protected state by a data W/R controller; and
when the second register is full, setting the second register to a write-protected state by the data W/R controller.

15. The method of claim 14, further comprising:
when the first register is in the write-protected state, storing the accessible data in the second register by the first multiplexer;
when the second register is in the write-protected state, storing the accessible data in the first register by the first multiplexer; and
when both of the first and second registers are in the write-protected state, suspending the accessible data transmitted from the signal collecting unit by the first multiplexer.

16. The method of claim 15, further comprising suspending collecting the real-time signals from the bus when both of the first and second registers are in the write-protected state.

17. The method of claim 16, further comprising:
when the second multiplexer has finished reading the accessible data from the first register, setting the first register to a write-permitted state by the data W/R controller; and
when the second multiplexer has finished reading the accessible data from the second register, setting the second register to a write-permitted state by the data W/R controller.

18. The method of claim 11, wherein each of the first and second registers is an FIFO register.

19. The method of claim 11, further comprising controlling an indicating lamp to flicker while the processing unit is examining the accessible data.

20. The method of claim 11, further comprising establishing a wireless connection with the control terminal and transmitting the status of the real-time signals to the control terminal via the wireless connection by a wireless network interface.
